(19) United States
(12) Patent Application Publication
(10) Pub. No.: US 2007/0088564 A1
(43) Pub. Date: Apr. 19, 2007

(54) Healthcare provider data submission and billing system and method

(75) Inventors: Glenville A. March JR., Los Angeles, CA (US); Richard E. Standridge, Chandler, AZ (US)

Correspondence Address: PATENT ADMINISTRATOR;KATTEN MUCHIN ROSENMAN LLP, 1025 THOMAS JEFFERSON STREET, N.W., EAST LOBBY: SUITE 700, WASHINGTON, DC, 20007-5201, US

(73) Assignee: R&G RESOURCES, LLC, Los Angeles, CA (US)

(21) Appl. No.: 11/248,328

(22) Filed: Oct. 13, 2005

(51) Int. Cl. G06Q 10/00; G06F 7/00

(52) U.S. Cl. 705/2; 707/102

(57) ABSTRACT

A healthcare insurance claim processing system and method generates a first set of data fields for display in a healthcare claim form. The first set includes requests for patient billing and medical information, and a request for a medical procedure code. The medical procedure code associated with a medical diagnosis of the patient is entered for at least one field of the first set of data fields. A second set of data fields is generated in accordance with the medical procedure code for display in the healthcare claim form. The second set of data fields includes requests for medical diagnostic information of the patient to assist in diagnosing a medical condition of the patient. The healthcare claim form with information from the first and second sets of data fields is submitted to a payer for payment of the health insurance claim associated with the medical condition of the patient.

### BACKGROUND

1. Field of the Invention

The present invention relates to medical billing and data collection and processing. More particularly, the present invention relates to a healthcare provider data submission and billing system and method.

2. Background Information

Insurance companies, health maintenance organizations (HMOs), government programs, such as, for example, Medicare and Medicaid, and other payers of health care claims generally receive claims for the payment of physician services rendered on a standard health insurance claim form, such as, for example, the CMS-1500 (Centers for Medicare & Medicaid Services) form (formerly the HCFA-1500 (Health Care Financing Administration) form). For example, the CMS-1500 form can be used by non-institutional providers and suppliers to bill Medicare, Part B covered services, and can be also be used for billing some Medicaid services. Other forms can be used for payment of different medical services. For example, the UB-92 (HCFA-1450) form can be used by institutional and other selected providers to complete a Medicare, Part A claim for submission to Medicare Fiscal Intermediaries. The CMS-1491 (Request for Medicare Payment-Ambulance) form can be used to bill Medicare, Part B covered ambulance services, although the CMS-1500 form can alternatively be used to bill for such services. The CMS-1490S (Patient's Request for Medicare Payment) form can be used by Medicare beneficiaries for billing Medicare covered services.

However, the use of the CMS-1500 form by billing physicians is typically required by most payers for the payment of physician services rendered. The CMS-1500 claim forms can be mailed to payers or submitted electronically. In either case, the information contained on the CMS-1500 forms is generally limited to conventional information related to the billing of services. For example, FIG. 1 is an illustration of a conventional CMS-1500 form 100 that can be used for billing physician services. The CMS-1500 form 100 includes a top section 105 for entering patient and insured information (items 1-13 in the form), and a bottom section 110 for entering physician or supplier information (items 14-33 in the form). The CMS-1500 form 100 further includes a diagnosis section 115 (item 21) in the bottom section 110 for entering rudimentary information (e.g., code numbers) regarding a patient's diagnosis and/or condition. The CMS-1500 form 100 also includes a payment section 120 in the bottom section 110 for entering information such as, for example, the dates on which services were rendered (item 24A), the place of service (item 24B), the type of service (item 24C), the procedures, services and/or supplies used for rendering the service (item 24D), and the charges for each service (item 24F).

Currently, any additional or alternative information requested or required by the payer that is not contained in or otherwise provided by the CMS-1500 form 100 must be collected independently by requesting additional documentation (from the physician or, ultimately, the patient) or by reviewing physician medical records. Such additional information can be difficult, time consuming and costly to collect, and is generally done in arrears, which can result in a low level of compliance by providers. The need for such additional information has, however, become increasingly important among payers who, to be efficient and competitive, collect and analyze more information about the services being rendered to their covered individuals. Moreover, governmental programs and regulatory agencies are increasingly requiring such additional information to measure compliance and to determine compensation to the payer.

### SUMMARY OF THE INVENTION

A healthcare provider data submission and billing system and method are disclosed. In accordance with exemplary embodiments of the present invention, according to a first aspect of the present invention, a system for processing a healthcare insurance claim includes a data generation module. The data generation module is configured to generate a first set of data fields. The first set of data fields includes requests for billing and medical information associated with a patient. At least one data field of the first set of data fields includes a request for a medical procedure code. The system includes a display module in communication with the data generation module. The display module is configured to display the first set of data fields to a user in a healthcare claim form. The medical procedure code associated with a medical diagnosis of the patient is entered into the at least one data field. The system includes a medical diagnostic module in communication with the data generation module and the display module. The medical diagnostic module is configured to generate a second set of data fields in accordance with the medical procedure code. The display module is configured to display the second set of data fields to the user in the healthcare claim form. The second set of data fields comprises requests for medical diagnostic information associated with the patient. The medical diagnostic information is configured to assist the user in diagnosing a medical condition of the patient. The healthcare claim form with information from the first and second sets of data fields is submitted to a payer for payment of the health insurance claim associated with the medical condition of the patient.

According to the first aspect, the medical procedure code can comprise one of a limited code, an intermediate code, and a comprehensive code. The comprehensive code can generate a greater number of requests for medical diagnostic information than for the intermediate code, and the intermediate code can generate a greater number of requests for medical diagnostic information than for the limited code. A value of the medical procedure code can be associated with a level of detail of requests for medical diagnostic information associated with the patient. For example, a high value of the medical procedure code can be associated with a basic request for medical diagnostic information associated with the patient, while a low value of the medical procedure code can be associated with a comprehensive request for medical diagnostic information associated with the patient. Medical procedure codes can be associated with medical specialties. The medical procedure code can comprise a current procedure terminology (CPT) code. Alternatively or additionally, the medical procedure code can comprise a healthcare common procedure coding system (HCPCS) code.

According to the first aspect, the system can include a communication module in communication with the data generation module and the medical diagnostic module. The communication module can be configured to transmit an electronic copy of the healthcare claim form to the payer. The system can include a printing module in communication with the data generation module and the medical diagnostic module. The printing module can be configured to print a hardcopy of the healthcare claim form for submission to the payer. The system can include a correspondence generation module in communication with the data generation module and the medical diagnostic module. The correspondence generation module can be configured to generate correspondence associated with the healthcare claim form. The correspondence can be populated with information from the first and second sets of data fields.

According to the first aspect, the medical diagnostic information associated with the patient can comprise information for determining diseases suffered by the patient. The medical diagnostic information associated with the patient can comprise information for determining whether a complete medical examination was given to the patient. The medical diagnostic information associated with the patient can comprise information for determining actions taken by a physician in performing a medical examination of a patient. The medical diagnostic information associated with the patient can comprise information for determining whether a patient is to be enrolled in a disease management program. The medical diagnostic module can comprise a rules engine. The display module can be configured to remotely display the healthcare claim form with the first and second sets of data fields through a Web browser via a computer network connection. The healthcare claim form can comprise a CMS-1500 health insurance claim form, a UB-92 healthcare insurance claim form or the like. According to an exemplary embodiment of the first aspect, the system can be complaint with a Health Insurance Portability and Accountability Act (HIPAA).

According to a second aspect of the present invention, a method of processing a healthcare insurance claim includes the steps of: a.) generating a first set of data fields for display to a user in a healthcare claim form, wherein the first set of data fields includes requests for billing and medical information associated with a patient, and wherein at least one data field of the first set of data fields includes a request for a medical procedure code; b.) entering the medical procedure code associated with a medical diagnosis of the patient into the at least one data field; c.) generating a second set of data fields in accordance with the medical procedure code for display to the user in the healthcare claim form, wherein the second set of data fields comprises requests for medical diagnostic information associated with the patient, and wherein the medical diagnostic information is configured to assist the user in diagnosing a medical condition of the patient; and d.) submitting the healthcare claim form with information from the first and second sets of data fields to a payer for payment of the health insurance claim associated with the medical condition of the patient.

According to the second aspect, the medical procedure code can comprise one of a limited code, an intermediate code, and a comprehensive code. The comprehensive code can generate a greater number of requests for medical diagnostic information than for the intermediate code, and the intermediate code can generate a greater number of requests for medical diagnostic information than for the limited code. A value of the medical procedure code can be associated with a level of detail of requests for medical diagnostic information associated with the patient. For example, a high value of the medical procedure code can be associated with a basic request for medical diagnostic information associated with the patient, while a low value of the medical procedure code can be associated with a comprehensive request for medical diagnostic information associated with the patient. Medical procedure codes can be associated with medical specialties. The medical procedure code can comprise a CPT code, a HCPCS code or the like.

According to the second aspect, step (d) can comprise the step of: d1.) transmitting an electronic copy of the healthcare claim form to the payer. Alternatively or additionally, step (d) can comprise the step of: d2.) printing a hardcopy of the healthcare claim form for submission to the payer. The method can include the step of: e.) generating correspondence associated with the healthcare claim form, wherein the correspondence is populated with information from the first and second sets of data fields.

According to the second aspect, the medical diagnostic information associated with the patient can comprise information for determining diseases suffered by the patient. The medical diagnostic information associated with the patient can comprise information for determining whether a complete medical examination was given to the patient. The medical diagnostic information associated with the patient can comprise information for determining actions taken by a physician in performing a medical examination of a patient. The medical diagnostic information associated with the patient can comprise information for determining whether a patient is to be enrolled in a disease management program. The healthcare claim form can comprise a CMS-1500 health insurance claim form, a UB-92 healthcare insurance claim form, or the like. According to an exemplary embodiment of the second aspect, the method can be complaint with HIPAA.

According to a third aspect, a system for processing a healthcare insurance claim includes means for generating data. The data generating means is configured to generate a first set of data fields. The first set of data fields includes requests for billing and medical information associated with a patient. At least one data field of the first set of data fields includes a request for a medical procedure code. The system includes means for displaying information in communication with the data generating means. The information displaying means is configured to display the first set of data fields to a user in a healthcare claim form. The medical procedure code associated with a medical diagnosis of the patient is entered into the at least one data field. The system includes means for medical diagnosing in communication with the data generating means and the information displaying means. The medical diagnosing means is configured to generate a second set of data fields in accordance with the medical procedure code. The information displaying means is configured to display the second set of data fields to the user in the healthcare claim form. The second set of data fields comprises requests for medical diagnostic information associated with the patient. The medical diagnostic information is configured to assist the user in diagnosing a medical condition of the patient. The healthcare claim form with information from the first and second sets of data fields is submitted to a payer for payment of the health insurance claim associated with the medical condition of the patient.

According to the third aspect, the medical procedure code can comprise one of a limited code, an intermediate code, and a comprehensive code. The comprehensive code can generate a greater number of requests for medical diagnostic information than for the intermediate code, and the intermediate code can generate a greater number of requests for medical diagnostic information than for the limited code. The value of the medical procedure code can be associated with a level of detail of requests for medical diagnostic information associated with the patient. For example, a high value of the medical procedure code can be associated with a basic request for medical diagnostic information associated with the patient, while a low value of the medical procedure code can be associated with a comprehensive request for medical diagnostic information associated with the patient. Medical procedure codes can be associated with medical specialties. The medical procedure code can comprise a CPT code, a HCPCS code or the like.

According to the third aspect, the system can include means for communicating in communication with the data generating means and the medical diagnosing means. The communicating means can be configured to transmit an electronic copy of the healthcare claim form to the payer. The system can include means for printing in communication with the data generating means and the medical diagnosing means. The printing means is configured to print a hardcopy of the healthcare claim form for submission to the payer. The system can include means for generating correspondence in communication with the data generating means and the medical diagnosing means. The correspondence generating means can be configured to generate correspondence associated with the healthcare claim form. The correspondence can be populated with information from the first and second sets of data fields.

According to the third aspect, the medical diagnostic information associated with the patient can comprise information for determining diseases suffered by the patient. The medical diagnostic information associated with the patient can comprise information for determining whether a complete medical examination was given to the patient. The medical diagnostic information associated with the patient can comprise information for determining actions taken by a physician in performing a medical examination of a patient. The medical diagnostic information associated with the patient can comprise information for determining whether a patient is to be enrolled in a disease management program. The medical diagnosing means can comprise a rules engine. The information displaying means can be configured to remotely display the healthcare claim form with the first and second sets of data fields through a Web browser via a computer network connection. The healthcare claim form can comprise, for example, a CMS-1500 health insurance claim form, a UB-92 healthcare insurance claim form or the like. According to an exemplary embodiment of the third aspect, the system can be complaint with HIPAA.

According to a fourth aspect of the present invention, a computer-readable medium contains a computer program for processing a healthcare insurance claim. The computer program performs the steps of: a.) generating a first set of data fields for display to a user in a healthcare claim form, wherein the first set of data fields includes requests for billing and medical information associated with a patient, and wherein at least one data field of the first set of data fields includes a request for a medical procedure code; b.) receiving the medical procedure code associated with a medical diagnosis of the patient into the at least one data field; c.) generating a second set of data fields in accordance with the medical procedure code for display to the user in the healthcare claim form, wherein the second set of data fields comprises requests for medical diagnostic information associated with the patient, and wherein the medical diagnostic information is configured to assist the user in diagnosing a medical condition of the patient; and d.) initiating submission of the healthcare claim form with information from the first and second sets of data fields to a payer for payment of the health insurance claim associated with the medical condition of the patient.

According to the fourth aspect, the medical procedure code can comprise one of a limited code, an intermediate code, and a comprehensive code. The comprehensive code can generate a greater number of requests for medical diagnostic information than for the intermediate code. The intermediate code can generate a greater number of requests for medical diagnostic information than for the limited code. The value of the medical procedure code can be associated with the level of detail of requests for medical diagnostic information associated with the patient. For example, a high value of the medical procedure code can be associated with a basic request for medical diagnostic information associated with the patient, while a low value of the medical procedure code can be associated with a comprehensive request for medical diagnostic information associated with the patient. Medical procedure codes can be associated with medical specialties. The medical procedure code can comprise, for example, a CPT code, a HCPCS code or the like.

According to the fourth aspect, for step (d) the computer program can perform the step of: d1.) initiating transmission of an electronic copy of the healthcare claim form to the payer. Alternatively or additionally, for step (d) the computer program can perform the step of: d1.) initiating printing a hardcopy of the healthcare claim form for submission to the payer. The computer program can perform the step of: e.) generating correspondence associated with the healthcare claim form. The correspondence can be populated with information from the first and second sets of data fields.

According to the fourth aspect, the medical diagnostic information associated with the patient can comprise information for determining diseases suffered by the patient. The medical diagnostic information associated with the patient can comprise information for determining whether a complete medical examination was given to the patient. The medical diagnostic information associated with the patient can comprise information for determining actions taken by a physician in performing a medical examination of a patient. The medical diagnostic information associated with the patient can comprise information for determining whether a patient is to be enrolled in a disease management program. The healthcare claim form can comprise, for example, a CMS-1500 health insurance claim form, a UB-92 healthcare insurance claim form, or the like. According to an exemplary embodiment of the fourth aspect, the computer program can be complaint with HIPAA.

According to a fifth aspect of the present invention, a system for processing a benefits claim includes an information generation module. The information generation module is configured to generate a first set of data fields. The first set of data fields includes requests for billing and benefits information associated with an individual. At least one data field of the first set of data fields includes a request for a benefits code. The system includes a display module in communication with the information generation module. The display module is configured to display the first set of data fields to a user in a benefits claim form. The benefits code associated with a benefit of the individual is entered into the at least one data field. The system includes a benefit analysis module in communication with the information generation module and the display module. The benefit analysis module is configured to generate a second set of data fields in accordance with the benefits code. The display module is configured to display the second set of data fields to the user in the benefits claim form. The second set of data fields comprises requests for benefits analysis information associated with the individual. The benefits analysis information is configured to assist the user in analyzing benefits for the individual. The benefits claim form with information from the first and second sets of data fields is submitted to a payer for payment of the benefits claim associated with the benefit of the individual.

### BRIEF DESCRIPTION OF THE DRAWINGS

Other objects and advantages of the present invention will become apparent to those skilled in the art upon reading the following detailed description of preferred embodiments, in conjunction with the accompanying drawings, wherein like reference numerals have been used to designate like elements, and wherein:

FIG. 1 is an illustration of a conventional CMS-1500 form that is used for billing physician services.

FIG. 2 is a block diagram illustrating a system for processing a healthcare insurance claim, in accordance with an exemplary embodiment of the present invention.

FIGS. 3A and 3B are diagrams illustrating a CMS-1500 form including a first set of data fields, in accordance with an exemplary embodiment of the present invention.

FIGS. 4A and 4B are diagrams illustrating a CMS-1500 form including a second set of data fields, in accordance with an exemplary embodiment of the present invention.

FIG. 5 is a flowchart illustrating steps for processing a healthcare insurance claim, in accordance with an exemplary embodiment of the present invention.

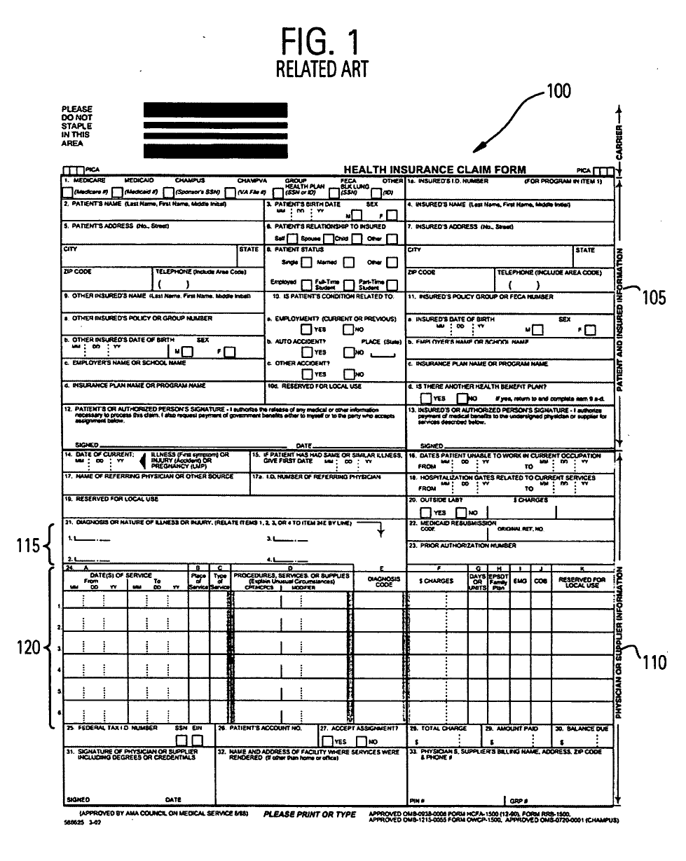

### DETAILED DESCRIPTION OF THE PREFERRED EMBODIMENTS

Exemplary embodiments of the present invention are directed to a healthcare provider data submission and billing system and method. According to an exemplary embodiment, a medical diagnostic module or unit is integrated with an electronic version of a standard health insurance claim form, such as a CMS-1500 or UB-92 form or the like. The medical diagnostic module can be configured to generate additional data fields that are displayed in the claim form. The nature and types of additional data fields or questions depend upon a medical procedure code entered into the claim form. Each medical procedure code entered generates a unique set of questions to be answered before the healthcare claim can be submitted. For example, if the medical procedure code for an examination of a new patient is entered, a set of questions can be displayed to the user requesting information about the actions taken by the physician, the time spent conducting the examination, any findings of disease states, such as, for example, hypertension, or other like questions. Questions or other data fields can be used to establish that the appropriate actions have been documented for the proper billing of a particular procedure, as required by the payer or by government regulations. Other questions can be used to identify patients that should be enrolled in, for example, a disease management or other like program. Additional or alternative questions or data fields can be used to report the completion of certain screening procedures or health data.

Conventionally, to document appropriate actions to support a charge for a particular medical procedure code, payers must request such additional documentation from the physician in arrears, generally after the healthcare claim has been submitted. Such a process can be costly and time consuming for both the physician and the payer. Such a process is also inefficient for identifying fraud. In contrast, exemplary embodiments of the present invention can require the physician to document appropriate actions as a condition of submitting the healthcare claim. Such documentation can be provided in conjunction with the claim submission by integrating the requests for such additional information into healthcare form. The nature and types of information requests can be based on the medical procedure code entered into the form. Using such a process can ensure that every healthcare claim can be submitted with the proper documentation and can eliminate the need for payers to obtain additional information in arrears.

Regarding questions that are designed to identify patients that should be enrolled in a disease management program, exemplary embodiments of the present invention can request specific information that indicates that the patient may be a candidate for a particular disease management program. For purposes of illustration and not limitation, an optometrist that performs an eye exam can be asked to enter the patient's intraocular pressure. If the intraocular pressure, used along with other information maintained or gathered according to exemplary embodiments, indicates that the patient may have, for example, hypertension, exemplary embodiments can notify the payer automatically. The payer can then enroll the patient into an appropriate disease management program for hypertension. Otherwise, the payer may never know or be made aware that the patient has hypertension. Enrolling the patient in a hypertension program can reduce payer costs and improve the patient's condition.

Regarding questions that are designed to report the completion of certain screening procedures or health data, certain governmental programs require contracted payers to provide data concerning the screening of patients for certain health conditions or report statistics related to procedures (e.g., Health Plan Employer Data Information Set (HEDIS), Early and Periodic Screening, Diagnostic and Treatment (EPSDT) or the like). The system and process according to exemplary embodiments can collect such data by automatically generating additional questions within or associated with the claim form for certain patients or health conditions. Such information can be transmitted directly to the payer in conjunction with the healthcare claim, thereby eliminating the need, for example, to send professional staff to the offices of the physicians to review medical records to records such data. Increasing numbers of governmental programs are requiring contracted payers to report such data to maintain their contract or to determine their compensation. Exemplary embodiments of the present invention can ensure the accurate collection of such data and a high level of reporting compliance.

The foregoing illustrations exemplify the nature and types of questions or data fields that the present invention can generate in a variety of circumstances, depending on the type of benefits being claimed. Exemplary embodiments can be customized to meet each payer's needs. For each particular circumstance or situation, each time a certain benefits code is entered into an appropriate electronic form, certain additional questions and/or data fields associated with the code can be displayed to the user within the benefits claim form to capture and automatically report the required and desired data.

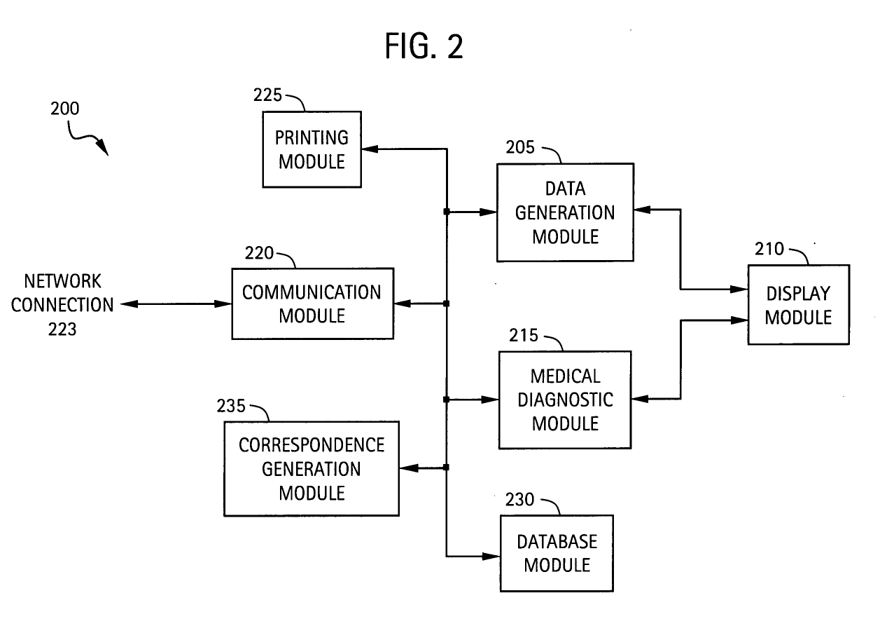

These and other aspects of the present invention will now be described in greater detail. FIG. 2 is a block diagram illustrating a system 200 for processing a healthcare insurance claim, in accordance with an exemplary embodiment of the present invention. The system 200 includes an information or data generation module 205. The data generation module 205 is configured to generate a first set of data fields. The system 200 includes a display module 210 in communication with the data generation module 205. The display module is configured to display the first set of data fields to a user in a benefits claim form, such as a healthcare claim form or the like.

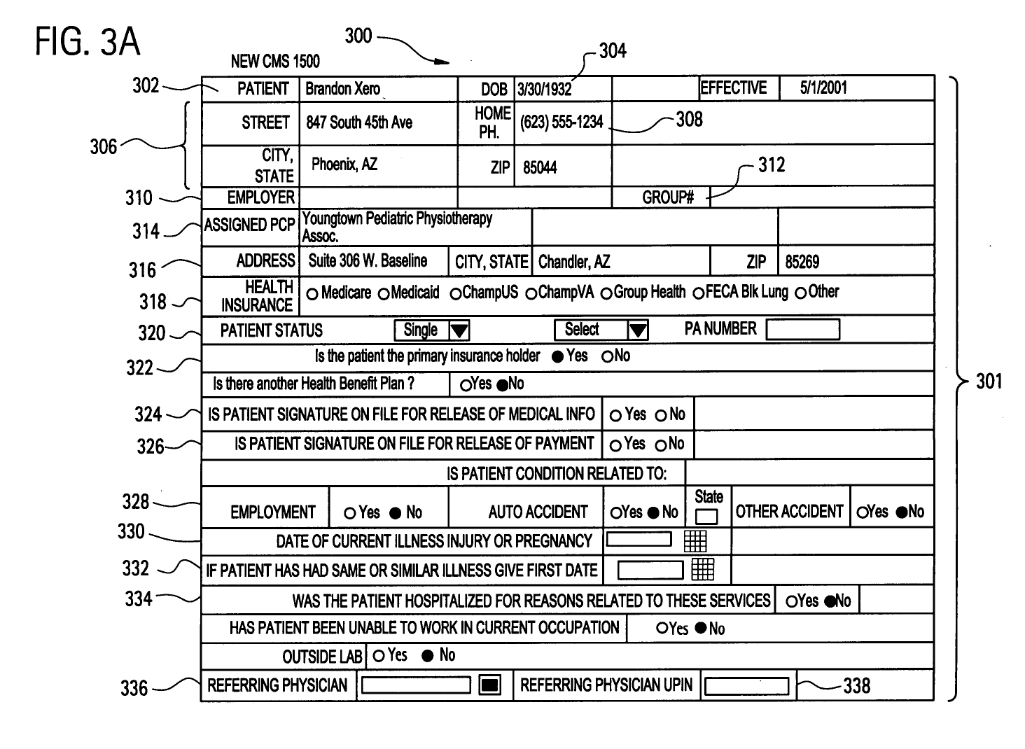

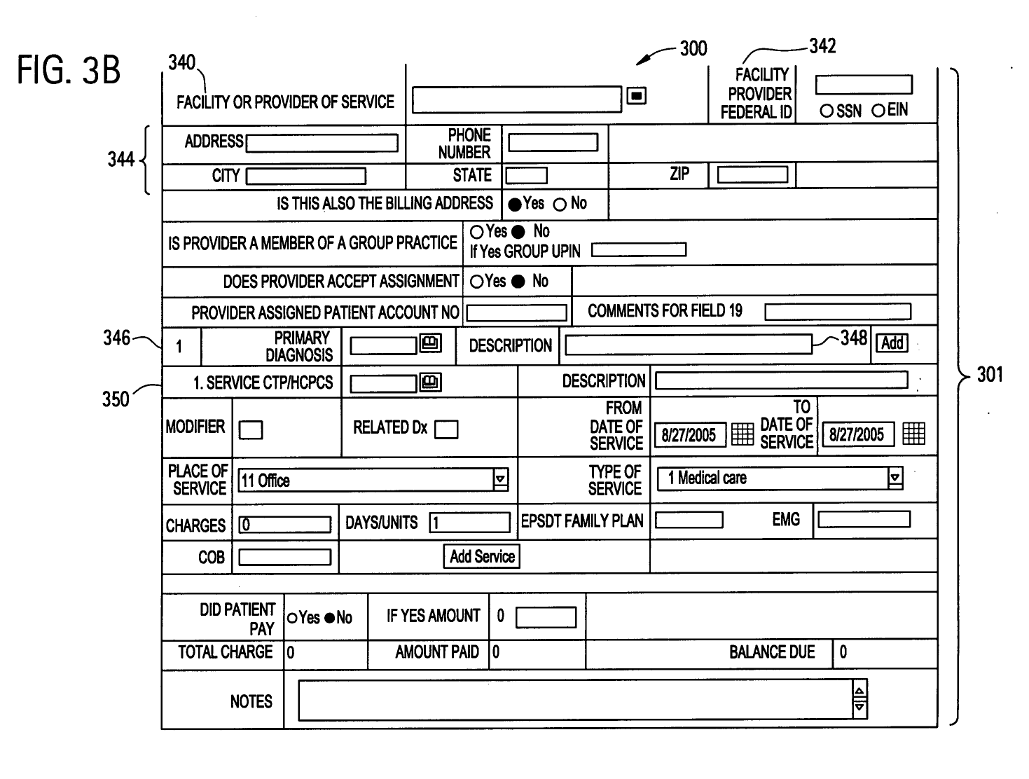

According to exemplary embodiments, the healthcare claim form can be any suitable type healthcare insurance or other benefit claim form or the like, such as, for example, a CMS-1500 form, a UB-92 form, a CMS-1491, a CMS-1490S form, or any other suitable type of benefits claim form that is capable of being electronically displayed or otherwise rendered to a user. According to an exemplary embodiment, the first set of data fields can include requests for billing and medical information associated with a patient. However, the first set of data fields can include requests for any suitable type of benefits information associated with an individual that can be used for completing an appropriate benefits claim form. For example, for purposes of illustration and not limitation, FIGS. 3A and 3B are diagrams illustrating a CMS-1500 form 300 including a first set of data fields 301, in accordance with an exemplary embodiment of the present invention. It is noted that the CMS-1500 form 300 illustrated in FIGS. 3A and 3B can be displayed to a user as either a single electronic image or as multiple electronic images, depending on such factors as, for example, the number of data fields, the size of individual data fields, the layout and design of the data fields, and other like factors.

As illustrated in FIG. 3A, the first set of data fields 301 in the CMS-1500 form 300 can include patient identification information, such as, for example, patient name 302, patient date of birth 304, patient address 306, patient phone number 308, patient employer 310, patient status 320 (e.g., single, married, divorced, widowed or the like), patient primary insurance holder designation 322, patient medical information signature release designation 324 (e.g., yes or no), and patient payment signature release designation 326 (e.g., yes or no). The first set of data fields 301 in the CMS-1500 form 300 can also include patient healthcare plan identifying information, such as group number 312, primary care physician (PCP) name 314, PCP address 316, and healthcare plan designation 318. The first set of data fields 301 in the CMS-1500 form 300 can also include patient condition relationship information 328, which can include information concerning whether the patient's condition is related to such factors as employment, auto accident, other accident, or the like. The first set of data fields 301 in the CMS-1500 form 300 can further include, for example, a date 330 of the current illness, a first date 332 of the illness if the patient has had the same or similar illness previously, and a hospitalization designation 334 for indicating whether the patient was hospitalized for reasons related to the rendered services. The first set of data fields 301 in the CMS-1500 form 300 can include a referring physician designation 336, and the referring physician's unique physician identification number (UPIN) 338.

As illustrated in FIG. 3B, the first set of data fields 301 in the CMS-1500 form 300 can also include a facility or provider of service designation 340, a facility provider federal identification number 342, and the address 344 of the facility or provider of the service. The first set of data fields 301 in the CMS-1500 form 300 can include additional requests for information associated with the facility or provider of service, such as, for example, whether the provide is a member of a group practice (and, if so, the UPIN of the group practice), whether the provider accepts the assignment of the patient, and any provider-assigned patient account number or other like patient designator. The first set of data fields 301 in the CMS-1500 form 300 can further include a primary diagnosis designation field 346 and accompanying diagnosis description field 348. For the primary diagnosis field 346, the user can enter a suitable code, such as an international classification of diseases (ICD) code, such as, for example, an ICD-9 code or the like, to classify the disease or injury of the patient. The first set of data fields 301 can include requests for any additional information that is required for healthcare claim forms, such as, for example, the CMS-1500 form or the like.

According to exemplary embodiments of the present invention, at least one data field of the first set of data fields includes a request for a medical procedure or other benefits code. For example, as illustrated in FIG. 3B, the first set of data fields 301 in the CMS-1500 form 300 can include a medical procedure code field 350. The medical procedure code is associated with a medical diagnosis of the patient. For example, the medical procedure code can correspond to different medical specialties. For example, the entire or substantially entire range of medical procedure codes can be subdivided into groups or sub-ranges of code values. A sub-range of code values can correspond to a particular medical specialty, such as, for example, ophthalmology, and individual codes within that sub-range can designate different types of diseases or injuries for that medical specialty (e.g., glaucoma). According to an exemplary embodiment, the medical procedure code can comprise a current procedure terminology (CPT) code, a healthcare common procedure coding system (HCPCS) code, or other suitable type of code capable of designating a medical diagnosis, disease or injury of the patient. For other types of benefits, the values and designations of the benefits code will depend on such factors as, for example, the nature and type of benefit, conditions associated with the benefit, and other like factors.

Referring to FIG. 2, the system 200 includes a benefits analysis or medical diagnostic module 215 in communication with the data generation module 205 and the display module 210. According to exemplary embodiments, the user enters the medical procedure code in the medical procedure code field 350. In response, the medical diagnostic module 215 is configured to generate a second set of data fields in accordance with the medical procedure code. The display module 210 is configured to display the second set of data fields to the user in the healthcare claim form, such as the CMS-1500 form. According to an exemplary embodiment, the second set of data fields is displayed to the user within the same benefits form, such as a healthcare claim form or the like, as the first set of data fields. However, the second set of data fields can be displayed to a user in a separate image or window that is associated with the first set of data fields.

Thus, according to exemplary embodiments, medical diagnostic module 215 can be configured to generate additional data fields that are displayed in the healthcare claim form, such as, for example, the CMS-1500 form 300 or other suitable type of form. The nature and types of the additional data fields, questions or requests for information of the second set of data fields depend upon the medical procedure or benefits code entered into the claim form in, for example, the medical procedure code field 350. Each medical procedure or benefits code entered can generate a unique set of questions to be answered before the benefits claim can be submitted. For example, if the medical procedure code for an examination of a new patient is entered, a set of questions can be displayed to the user requesting information about the actions taken by the physician, the time spent conducting the examination, any findings of disease states, such as, for example, hypertension, or other like questions. Questions or other data fields can be used to establish that the appropriate actions have been documented for the proper billing of a particular procedure, as required by the payer or by government regulations. Other questions can be used to identify patients that should be enrolled in, for example, a disease management or other like program. Additional or alternative questions or data fields can be used to report the completion of certain screening procedures or health data.

Thus, according to exemplary embodiments, the second set of data fields can comprise requests for benefits analysis or medical diagnostic information associated with the patient or individual. The benefits analysis information can be configured to assist the user in analyzing benefits for the individual. For example, the medical diagnostic information can be configured to assist the user (e.g., a physician or other medical service provider) in diagnosing a medical condition (e.g., disease, injury or other medical condition) of the patient. For example, the medical diagnostic information associated with the patient can include information for determining diseases or injuries suffered by the patient. Alternatively or additionally, the medical diagnostic information can include information for determining whether a complete medical examination was given to the patient. Further, the medical diagnostic information can include information for determining actions taken by a physician in performing a medical examination of a patient. Additionally or alternatively, the medical diagnostic information can include information for determining whether a patient is to be enrolled in a disease management program. However, the medical diagnostic information can comprise any suitable information that can assist the physician or service provider is diagnosing the patient's medical condition.

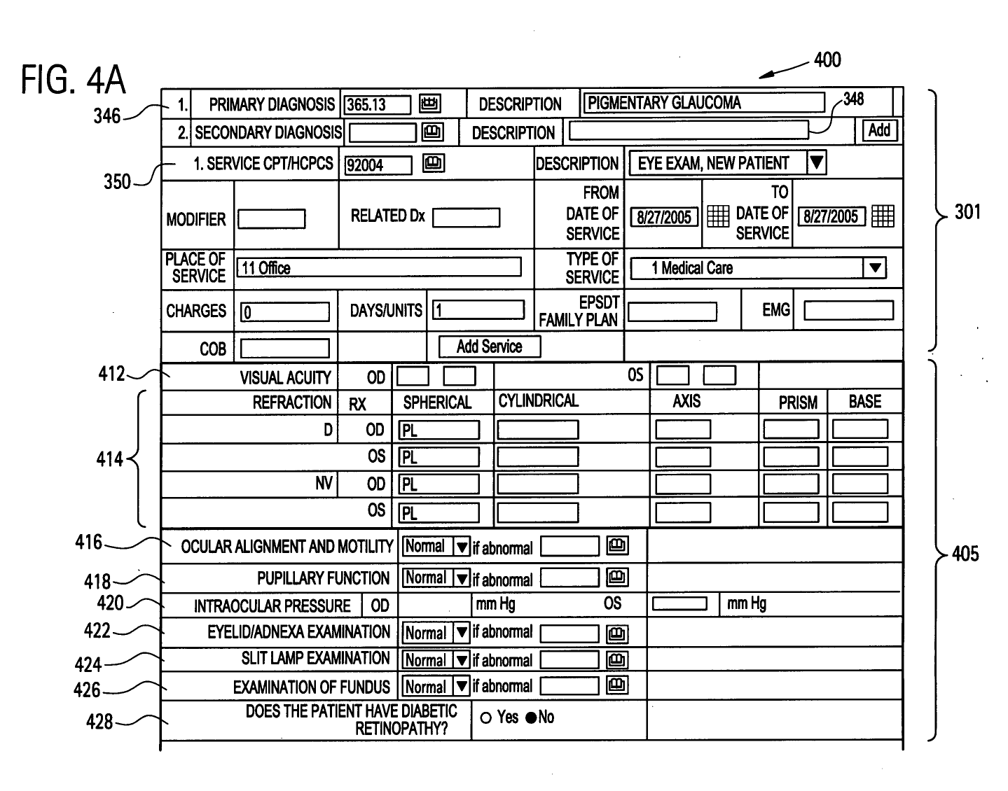

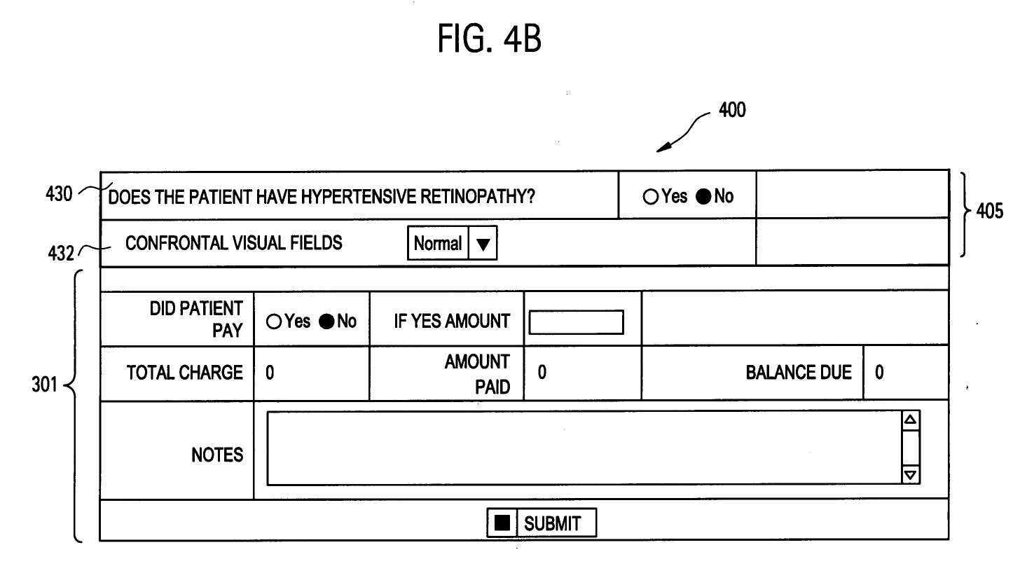

For purposes of illustration and not limitation, a code of 365.13 can be entered into the primary diagnosis designation field 346 in the CMS-1500 form 300 illustrated in FIG. 3B, with a description of “PIGMENTARY GLAUCOMA” entered in the corresponding diagnosis description field 348 (either automatically or manually based on the 365.13 code). If a medical procedure code such as, for example, 92004 (e.g., a medical procedure code for an eye exam for a new patient), is entered into the medical procedure code field 350, the second set of data fields corresponding to the medical procedure code of 92004 can be displayed to the user within the healthcare claim form. FIGS. 4A and 4B are diagrams illustrating a CMS-1500 form 400 including a second set of data fields 405, in accordance with an exemplary embodiment of the present invention. For purposes of clarity and conciseness, certain data fields from the first set of data fields 301 (e.g., those illustrated in FIG. 3A) are not illustrated in FIGS. 4A and 4B, although such data fields would be displayed to the user by the display module 210 for, for example, the CMS-1500 form 400.

As illustrated in FIGS. 4A and 4B, the second set of data fields 405 corresponding to medical procedure code 92004 is displayed within the CMS-1500 form 400, along with the first set of data fields 301 from the CMS-1500 form 300. For example, the second set of data fields 405 can be displayed below the medical procedure code field 350, although the second set of data fields 405 can be displayed at any appropriate location within the benefits or healthcare claim form, or as a separate electronic image or window. Additionally, it is noted that the CMS-1500 form 400 illustrated in FIGS. 4A and 4B can be displayed to a user as either a single electronic image or as multiple electronic images, depending on such factors as, for example, the number of data fields, the size of individual data fields, the layout and design of the data fields, and other like factors.

As illustrated in FIG. 4A, the medical procedure code of 92004, representing an eye examination for a new patient, can generate a second set of data fields 405 in the CMS-1500 form 400 that correspond to or are otherwise associated with an eye examination of a new patient. For example, the second set of data fields 405 in the CMS-1500 form 400 can include a visual acuity fields 412 for entering visual acuity information, and refraction identification fields 414 for entering prescription information for glasses or contact lenses (e.g., spherical, cylindrical, axis, prism and base specifications). The second set of data fields 405 in the CMS-1500 form 400 can also include an ocular alignment and motility field 416 (e.g., normal or abnormal), a pupillary function field 418 (e.g., normal or abnormal), an intraocular pressure field 420, an eyelid/adnexa examination field 422 (e.g., normal or abnormal), a slit lamp examination field 424 (e.g., normal or abnormal), a fundus examination field 426 (e.g., normal or abnormal), and a diabetic retinopathy designation field 428 (e.g., yes or no). As illustrated in FIG. 4B, the second set of data fields 405 in the CMS-1500 form 400 can further include a hypertensive retinopathy designation field 430 (e.g., yes or no), and a confrontal visual fields field 432 (e.g., normal or abnormal). As discussed previously, the nature and types of data fields in the second set of data fields 405 will vary depending upon the benefits or medical procedure code entered into the benefits form, such as into medical procedure code field 350 in the CMS-1500 form 300.

Different benefits codes can be used for different types or levels of benefits. For example, different medical procedure codes and ranges of medical procedure codes can be used for each medical specialty. According to an alternative exemplary embodiment, the medical procedure codes can be reused for each medical specialty, although the meaning of those codes will change based on the medical specialty. For example, when a physician logs into the system 200 (e.g., via display module 210), the medical diagnostic module 215 can determine the medical specialty to which the physician belongs based on the login account information that has been set up and stored for that physician. The medical diagnostic module 215 can then use the medical procedure codes for that specialty when generating the second set of data fields 405. For example, for an ophthalmologist, the medical procedure code of 92004 can correspond to an eye examination for a new patient. However, for an dermatologist, the medical procedure code of 92004 can correspond to a skin cancer screening for a new patient.

Using the information provided in the second set of data fields 405, the physician or other service provider can diagnose the medical condition of the patient or otherwise analyze the benefits associated with the individual. According to an exemplary embodiment, the medical diagnostic module 215 can comprise any suitable type of rules engine. For example, based on the medical procedure code and the corresponding information entered into the second set of data fields 405, the rules engine can formulate a diagnosis of the medical condition of the patient, for example, by using a look-up table to cross-reference the disease or injury based on the information supplied in the second set of data fields 405. The diagnosis can then be displayed to the user (e.g., the physician or other service provider) by the display module 210 or supplied to the payer for further analysis or processing. Additionally, the information requested by and supplied to the second set of data fields 405 can also be used to help formulate a course of treatment for the diagnosed medical condition. For purposes of illustration and not limitation, an optometrist that performs an eye exam can be asked to enter the patient's intraocular pressure, for example, in the intraocular pressure field 420 in CMS-1500 form 400. If the value of the intraocular pressure, used by the rules engine of the medical diagnostic module 215 along with other information gathered in the second set of data fields 405, indicates that the patient may have, for example, hypertension, exemplary embodiments can notify the physician or the payer automatically. The physician or the payer can then enroll the patient into an appropriate disease management program for hypertension.

According to an exemplary embodiment, the benefits or medical procedure code can comprise a limited code, an intermediate code, or a comprehensive code. For example, by entering a limited code for the medical procedure code, a basic set of requests for medical diagnostic information can be displayed to the user for the second set of data fields 405. Such a limited code can be used to enter rudimentary or summary medical diagnostic information into the healthcare claim form. An intermediate code can cause the generation of a more detailed set of requests for medical diagnostic information. For example, an intermediate code can be used to obtain more detailed medical diagnostic information of the patient than that obtained from a limited code. A comprehensive code can cause the generation of a comprehensive set of detailed requests for medical diagnostic information. For example, medical procedure code 92004 can be considered an example of a comprehensive code. Thus, the comprehensive code can generate a greater number of requests for medical diagnostic information than for the intermediate code, and the intermediate code can generate a greater number of requests for medical diagnostic information than for a limited code.

Additionally, the value of the medical procedure code can be associated with the level of detail of requests for medical diagnostic information associated with the patient. For example, a high value of the medical procedure code (e.g., a high value of either the limited, intermediate or comprehensive code) can be associated with a basic request for medical diagnostic information associated with the patient. Alternatively, a low value of the medical procedure code (e.g., a low value of either the limited, intermediate or comprehensive code) can be associated with a more comprehensive request for medical diagnostic information associated with the patient. Accordingly, the resulting diagnosis of the medical condition of the patient provided by, for example, the medical diagnostic module 215 or arrived at by, for example, the physician based on the information provided by the medical diagnostic module 215 can depend on the type of medical procedure code entered (whether limited, intermediate or comprehensive, and whether a high value or a low value). As discussed previously, the nature and types of requests for medical diagnostic information will depend on the entered medical procedure code.

Once the information requested by the first and second sets of data fields 301 and 405 has been provided by the user and entered into the benefits claim form according to exemplary embodiments, the completed benefits claim form can be submitted to the payer (e.g., the health insurance company or other payer) for payment of the benefits claim. Referring to FIG. 2, the system 200 can include a communication module 220 in communication with the data generation module 205 and the medical diagnostic module 215. The communication module 205 can be configured to transmit an electronic copy of the benefits form to the payer, e.g., via the computer network (e.g., Internet) connection 223 (e.g., by electronic mail, upload to a payer's website or the like). Alternatively, the system 200 can include a printing module 225 in communication with the data generation module 205 and the medical diagnostic module 215. The printing module 225 can be configured to print a hardcopy of the benefits form for submission to the payer (e.g., by postal mail or fax).

Additionally, the system 200 can include a database module 230 for storing the information from the first and second sets of data fields 301 and 405 for later retrieval. For example, the retrieved data can be displayed to the user by the display module 210 to review, edit or update the information. The database module 230 can be comprised of any suitable type of electronic storage medium capable of storing such electronic information. The system 200 can also include a correspondence generation module 235 in communication with the data generation module 205 and the medical diagnostic module 215. The correspondence generation module 235 can be configured to generate correspondence associated with the benefits form, in which the correspondence is populated with information from the first and second sets of data fields 301 and 405 that is retrieved from the database module 230.

Thus, the healthcare provider data submission and billing system and method according to exemplary embodiments can provide healthcare providers with the ability to submit data and billing simultaneously. Such an exemplary system and process can eliminate the need for payers of healthcare claims to collect data separately, can provide payers with real-time encounter information for analysis and reporting purposes, can allow payers to document the proper coding of claims, can assist payers in the identification of fraudulent billing, and can reduces costs. According to exemplary embodiments, the system 200 can be compliant with the Health Insurance Portability and Accountability Act (HIPAA) or any other suitable healthcare statutes, regulations or provisions.

The system 200 can also include any suitable type of graphical user interface for use by the display module 210 and configured to provide access to, either locally or remotely, and management of the system 200. For example, the display module 210 can be configured to remotely display the benefits form with the first and second sets of data fields 301 and 405 through a Web browser via a computer network connection (e.g., network connection 223). Thus, the graphical user interface can be, for example, any suitable type of Web browser that can support, for example, secure connections and remote access to the system 200. The graphical user interface can be displayed on any suitable computer display or monitor capable of displaying graphical and/or textual information to a user and which allows a user to enter information (e.g., commands, information and the like) through, for example, a keyboard, a touch-screen, any type of pointing device, electronic pen, and the like. The graphical user interface can be used by the user to access, control and manage any and all of the functionality of the system 200, including viewing and managing an individual's benefit information, a patient's medical records or history and the like.

Each of modules of system 200, including the data generation module 205, the display module 210, the medical diagnostic module 215, the communication module 220, the printing module 225, the database module 230 and the correspondence generation module 235, or any combination thereof, can be comprised of any suitable type of electrical or electronic component or device that is capable of performing the functions associated with the respective element. According to such an exemplary embodiment, each component or device can be in communication with another component or device using any appropriate type of electrical connection that is capable of carrying electrical information. Alternatively, each of the modules of system 200 can be comprised of any combination of hardware, firmware and software that is capable of performing the function associated with the respective module. In addition, network communication link 223 can be comprised of any suitable type of communication medium or channel capable of transmitting and receiving electrical information.

Alternatively, the system 200 can be comprised of a microprocessor and associated memory that stores the steps of a computer program to perform the functions of the modules of the system 200. The microprocessor can be any suitable type of processor, such as, for example, any type of general purpose microprocessor or microcontroller, a digital signal processing (DSP) processor, an application-specific integrated circuit (ASIC), a programmable read-only memory (PROM), an erasable programmable read-only memory (EPROM), an electrically-erasable programmable read-only memory (EEPROM), a computer-readable medium, or the like. The memory can be any suitable type of computer memory or any other type of electronic storage medium, such as, for example, read-only memory (ROM), random access memory (RAM), cache memory, compact disc read-only memory (CDROM), electro-optical memory, magneto-optical memory, or the like. As will be appreciated based on the foregoing description, the memory can be programmed using conventional techniques known to those having ordinary skill in the art of computer programming. For example, the actual source code or object code of the computer program can be stored in the memory.

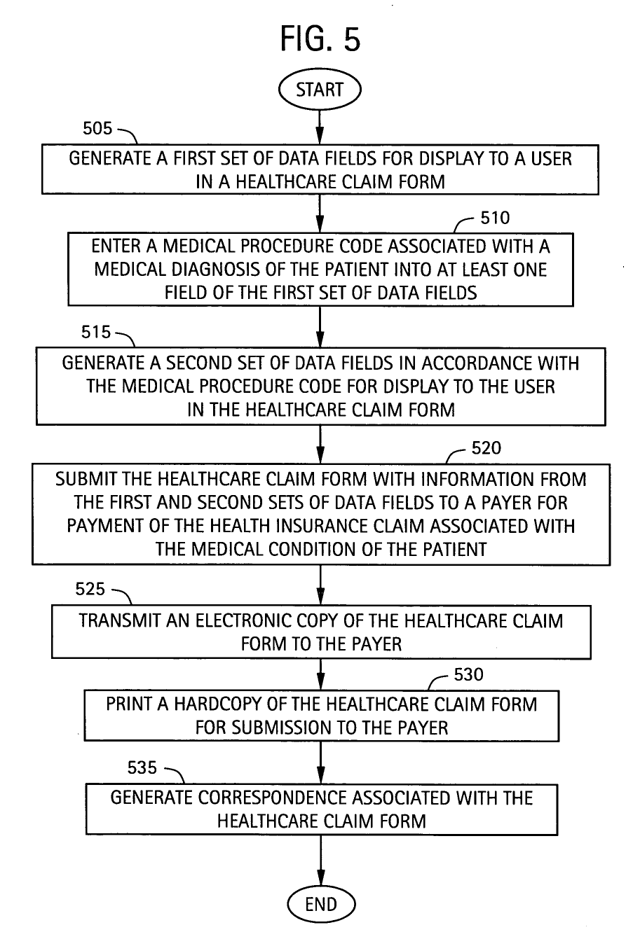

FIG. 5 is a flowchart illustrating steps for processing a healthcare insurance claim, in accordance with an exemplary embodiment of the present invention. In step 505, a first set of data fields is generated for display to a user in a healthcare claim form. As discussed previously, the benefits claim form can be any suitable type benefits claim form or the like, such as, for example, a CMS-1500 form, a UB-92 form, a CMS-1491, a CMS-1490S form, or any other suitable type of benefits claim form that is capable of being electronically displayed or otherwise rendered to a user. For example, the first set of data fields can include requests for billing and medical information associated with a patient. At least one data field of the first set of data fields includes a request for a benefits or medical procedure code. In step 510, the medical procedure code associated with a medical diagnosis of the patient is entered into the at least one data field. In step 515, a second set of data fields is generated in accordance with the medical procedure code for display to the user in the healthcare claim form. The second set of data fields comprises requests for benefits analysis or medical diagnostic information associated with the patient or individual. The benefits analysis information is configured to assist the user in analyzing benefits for the individual. For example, the medical diagnostic information can be configured to assist the user in diagnosing a medical condition of the patient. In step 520, the benefits or healthcare claim form with information from the first and second sets of data fields is submitted to a payer for payment of the benefits or health insurance claim associated with the benefits or medical condition of the patient.

To submit the benefit claim form, in step 525, an electronic copy of the benefits or healthcare claim form can be transmitted to the payer. Alternatively or additionally, in step 530, a hardcopy of the benefits or healthcare claim form can be printed for submission to the payer. In step 535, correspondence associated with the benefits or healthcare claim form can be generated. The correspondence can be populated with information from the first and second sets of data fields. According to an exemplary embodiment of the present invention, the method can be compliant with HIPAA or any other suitable healthcare statutes, regulations or provisions

One or more step for processing a healthcare insurance claim as illustrated in FIG. 5 can be performed by a computer program can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. As used herein, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

Exemplary embodiments of the present invention can be used in conjunction with any device, system, process or transaction for submitting a claim for benefits to a payer, such as, for example, healthcare insurance claims in a healthcare insurance claim form, such as the CMS-1500 form or the like. For example, exemplary embodiments can be used by physicians or other service providers to submit healthcare data and billing simultaneously to a payer.

It will be appreciated by those of ordinary skill in the art that the present invention can be embodied in various specific forms without departing from the spirit or essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

All United States patents and applications, foreign patents, and publications discussed above are hereby incorporated herein by reference in their entireties.

What is claimed is:

1. A system for processing a healthcare insurance claim, comprising:
a data generation module,
wherein the data generation module is configured to generate a first set of data fields,
wherein the first set of data fields includes requests for billing and medical information associated with a patient, and
wherein at least one data field of the first set of data fields includes a request for a medical procedure code;
a display module in communication with the data generation module,
wherein the display module is configured to display the first set of data fields to a user in a healthcare claim form, and
wherein the medical procedure code associated with a medical diagnosis of the patient is entered into the at least one data field; and
a medical diagnostic module in communication with the data generation module and the display module,
wherein the medical diagnostic module is configured to generate a second set of data fields in accordance with the medical procedure code,
wherein the display module is configured to display the second set of data fields to the user in the healthcare claim form,
wherein the second set of data fields comprises requests for medical diagnostic information associated with the patient,
wherein the medical diagnostic information is configured to assist the user in diagnosing a medical condition of the patient, and
wherein the healthcare claim form with information from the first and second sets of data fields is submitted to a payer for payment of the health insurance claim associated with the medical condition of the patient.

2. The system of claim 1, wherein the medical procedure code comprises one of a limited code, an intermediate code, and a comprehensive code.

3. The system of claim 2, wherein the comprehensive code generates a greater number of requests for medical diagnostic information than for the intermediate code,
and wherein the intermediate code generates a greater number of requests for medical diagnostic information than for the limited code.

4. The system of claim 1, wherein a value of the medical procedure code is associated with a level of detail of requests for medical diagnostic information associated with the patient.

5. The system of claim 4, wherein a high value of the medical procedure code is associated with a basic request for medical diagnostic information associated with the patient.

6. The system of claim 4, wherein a low value of the medical procedure code is associated with a comprehensive request for medical diagnostic information associated with the patient.

7. The system of claim 1, wherein medical procedure codes are associated with medical specialties.

8. The system of claim 1, wherein the medical procedure code comprises a current procedure terminology (CPT) code.

9. The system of claim 1, wherein the medical procedure code comprises a healthcare common procedure coding system (HCPCS) code.

10. The system of claim 1, comprising:
a communication module in communication with the data generation module and the medical diagnostic module,
wherein the communication module is configured to transmit an electronic copy of the healthcare claim form to the payer.

11. The system of claim 1, comprising:
a printing module in communication with the data generation module and the medical diagnostic module,
wherein the printing module is configured to print a hardcopy of the healthcare claim form for submission to the payer.

12. The system of claim 1, comprising:
a correspondence generation module in communication with the data generation module and the medical diagnostic module,
wherein the correspondence generation module is configured to generate correspondence associated with the healthcare claim form, and
wherein the correspondence is populated with information from the first and second sets of data fields.

13. The system of claim 1, wherein the medical diagnostic information associated with the patient comprises information for determining diseases suffered by the patient.

14. The system of claim 1, wherein the medical diagnostic information associated with the patient comprises information for determining whether a complete medical examination was given to the patient.

15. The system of claim 1, wherein the medical diagnostic information associated with the patient comprises information for determining actions taken by a physician in performing a medical examination of a patient.

16. The system of claim 1, wherein the medical diagnostic information associated with the patient comprises information for determining whether a patient is to be enrolled in a disease management program.

17. The system of claim 1, wherein the medical diagnostic module comprises a rules engine.

18. The system of claim 1, wherein the display module is configured to remotely display the healthcare claim form with the first and second sets of data fields through a Web browser via a computer network connection.

19. The system of claim 1, wherein the healthcare claim form comprises a CMS-1500 health insurance claim form.

20. The system of claim 1, wherein the healthcare claim form comprises a UB-92 healthcare insurance claim form.

21. The system of claim 1, wherein the system is complaint with a Health Insurance Portability and Accountability Act (HIPAA).

22. A method of processing a healthcare insurance claim, comprising the steps of:
a.) generating a first set of data fields for display to a user in a healthcare claim form,
wherein the first set of data fields includes requests for billing and medical information associated with a patient, and
wherein at least one data field of the first set of data fields includes a request for a medical procedure code;
b.) entering the medical procedure code associated with a medical diagnosis of the patient into the at least one data field;
c.) generating a second set of data fields in accordance with the medical procedure code for display to the user in the healthcare claim form,
wherein the second set of data fields comprises requests for medical diagnostic information associated with the patient, and
wherein the medical diagnostic information is configured to assist the user in diagnosing a medical condition of the patient; and
d.) submitting the healthcare claim form with information from the first and second sets of data fields to a payer for payment of the health insurance claim associated with the medical condition of the patient.

23. The method of claim 22, wherein the medical procedure code comprises one of a limited code, an intermediate code, and a comprehensive code.

24. The method of claim 22, wherein a value of the medical procedure code is associated with a level of detail of requests for medical diagnostic information associated with the patient.

25. The method of claim 22, wherein step (d) comprises the step of:
d1.) transmitting an electronic copy of the healthcare claim form to the payer.

26. The method of claim 22, wherein step (d) comprises the step of:
d1.) printing a hardcopy of the healthcare claim form for submission to the payer.

27. The method of claim 22, comprising the step of:
e.) generating correspondence associated with the healthcare claim form,
wherein the correspondence is populated with information from the first and second sets of data fields.

28. The method of claim 22, wherein the medical diagnostic information associated with the patient comprises information for determining diseases suffered by the patient.

29. The method of claim 22, wherein the medical diagnostic information associated with the patient comprises information for determining whether a patient is to be enrolled in a disease management program.

30. A system for processing a benefits claim, comprising:
an information generation module,
wherein the information generation module is configured to generate a first set of data fields,
wherein the first set of data fields includes requests for billing and benefits information associated with an individual, and
wherein at least one data field of the first set of data fields includes a request for a benefits code;
a display module in communication with the information generation module,
wherein the display module is configured to display the first set of data fields to a user in a benefits claim form, and
wherein the benefits code associated with a benefit of the individual is entered into the at least one data field; and
a benefit analysis module in communication with the information generation module and the display module,
wherein the benefit analysis module is configured to generate a second set of data fields in accordance with the benefits code,
wherein the display module is configured to display the second set of data fields to the user in the benefits claim form,
wherein the second set of data fields comprises requests for benefits analysis information associated with the individual,
wherein the benefits analysis information is configured to assist the user in analyzing benefits for the individual, and
wherein the benefits claim form with information from the first and second sets of data fields is submitted to a payer for payment of the benefits claim associated with the benefit of the individual.
